(19) United States
(12) Patent Application Publication
(10) Pub. No.: US 2008/0142487 A1
(43) Pub. Date: Jun. 19, 2008

(54) Automatic Wire Threader

(75) Inventor: Masashi Sakaguchi, Kanagawa (JP)

Correspondence Address: MCDERMOTT WILL & EMERY LLP, 18191 VON KARMAN AVE., SUITE 500, IRVINE, CA, 92612-7108, US

(73) Assignee: SODICK CO., LTD.

(21) Appl. No.: 10/585,734

(22) PCT Filed: Oct. 13, 2005
(86) PCT No.: PCT/JP2005/019265

§ 371 Date: Feb. 11, 2008

(30) Foreign Application Priority Data
Oct. 13, 2004 (JP) 2004-298882

(51) Int. Cl. B23H 7/08

(52) U.S. Cl. 219/69.12

(57) ABSTRACT

An automatic wire threader (1) for threading a wire electrode (2) through upper and lower wire guides is provided with means for annealing and fusing the wire electrode. Upper and lower energized electrodes (20, 22) are provided above the upper wire guide (3) for supplying heating current to the wire electrode. A vertically moveable guide pipe (24) through which the wire electrode can pass is provided between the upper and lower energized electrodes. A heat retention unit (28) having a through hole (50) through which the guide pipe can pass is provided between the upper and lower energized electrodes. A coolant supply unit (26) supplies coolant for cooling the wire electrode in the guide pipe. A blocking fluid supply unit (34) supplies blocking fluid for preventing coolant flowing into the through hole of the heat retention unit.

### TECHNICAL FIELD

The present invention relates to a wire electric discharge machine for machining a workpiece using a wire electrode suspended between a pair of wire guides. The present invention particularly relates to an automatic wire threader (“AWT”) for threading a wire electrode through a pair of wire guides.

### BACKGROUND ART

In general, a wire electric discharge machine cuts a workpiece like a coping saw using a wire electrode suspended between a pair of wire guides. In recent years, in almost all cases, a wire electrode with a diameter f of 0.3 mm or less is used, but there are also cases where a wire electrode with a diameter f of 0.1 mm or less is used. A wire guide has a small hole through which a wire electrode is passed, with a small clearance between the wire electrode and the wire guide being 3 μm to 5 μm, and a large clearance 20 μm at most. A lot of wire electric discharge machines are provided with an automatic wire threader for threading a wire electrode through upper and lower wire guides. An automatic wire threader threads a wire electrode into a start hole or machined kerf formed in a workpiece whenever necessary. The diameter of the start hole is less than 1 mm, and the width of the machined kerf is several hundred μm. The success rate of the automatic threading has a direct effect on machining efficiency, and is preferably close to 100%. In many cases, the wire electrode is twisted up. Wire electrodes that are extremely fine are not rigid and are susceptible to bending. Also, the leading end of a wire electrode when unforeseen breakage occurs is in a damaged condition. Accordingly, when the workpiece is thick, the success rate of the wire threading is lowered.

Japanese patent No. 7-29246 discloses a guide pipe capable of moving vertically through upper and lower guide assemblies. The wire electrode is guided by a fluid jet supplied inside the guide pipe. This type of method is known as a “pipe jet” method.

It is known to correct twists using annealing to thus straighten the wire electrode. In order to increase the success rate of automatic threading, it is preferable to anneal a wire electrode of a length equivalent to a distance between upper and lower wire guides. Japanese patent No. 61-26455 discloses a method of annealing a wire electrode between a pair of energized electrodes, and fusing separate energized electrodes after elongation to make the wire electrode thinner. Using this method, the wire electrode has a tapering round tip, and is straight. An automatic wire threader provided with an annealing unit and some sort of cutting unit is disclosed in Japanese patent Nos. 62-4523, 2686796 and 2715027.

Japanese Utility model No. 1-35785 and Japanese patent No. 2518040 disclose a pair of energized electrodes for annealing and fusing the wire electrode. Since no cutting device is required, the wire threader is simplified and reduces the time required for threading. However, a disadvantage is that the position where the wire electrode is fused is not defined.

Japanese patent No. 3371014 discloses a pair of energized electrodes for annealing and fusing the wire electrode, and a guide pipe provided between the pair of energized electrodes. The guide pipe is partitioned by a dividing wall, but the wire electrode can pass through the guide pipe via the dividing wall. Coolant is injected into the guide pipe from above, but the dividing wall prevents leaking of the coolant to the lower part of the guide pipe. In this way, the wire electrode is melted at a particular place that is sheltered from the coolant, namely the lower part of the guide pipe.

An object of the present invention is to provide an automatic wire threader that can reduce the time required for threading and is simplified.

Another object of the present invention is to provide an automatic wire threader that can anneal and fuse a wire electrode without impairing the advantage of a pipe jet method.

A further object of the present invention is to provide an automatic wire threader that fuses the wire electrode at a specified place.

### DISCLOSURE OF THE INVENTION

According to the present invention, an automatic wire threader, for threading a wire electrode through upper and lower wire guides, comprises:

upper and lower energized electrodes for supplying heating current to the wire electrode, provided above the upper wire guide;

a vertically moveable guide pipe through which a wire electrode can pass, provided between the upper and lower energized electrodes;

a heat retention unit, having a through hole through which the guide pipe can pass, provided between the upper and lower energized electrodes;

a coolant supply unit for supplying coolant for cooling the wire electrode in the guide pipe; and

a blocking fluid supply unit for supplying blocking fluid for preventing coolant flowing into the through hole of the heat retention unit.

Preferably, a nozzle for generating a flow of blocking fluid traversing the wire electrode in a gap formed between the guide pipe and the heat retention unit is provided.

More preferably, a blocking plate for preventing coolant flowing into the through hole of the heat retention unit is provided.

Other novel features of the invention will be described in the following description.

### BRIEF DESCRIPTION OF THE DRAWINGS

FIG. 1 is a plan view showing a wire electric discharge machine provided with the automatic wire threader of the present invention.

FIG. 2 is a cross sectional view showing the automatic wire threader of FIG. 1

FIG. 3 is a cross sectional view showing peripheral sections of a heat retention unit in the automatic wire threader of FIG. 2.

FIG. 4 is a perspective view showing a blocking plate in FIG. 2.

FIG. 5 is a cross sectional view showing peripheral sections of a heat retention unit in another automatic wire threader of the present invention.

### DETAILED DESCRIPTION OF THE PREFERRED EMBODIMENTS

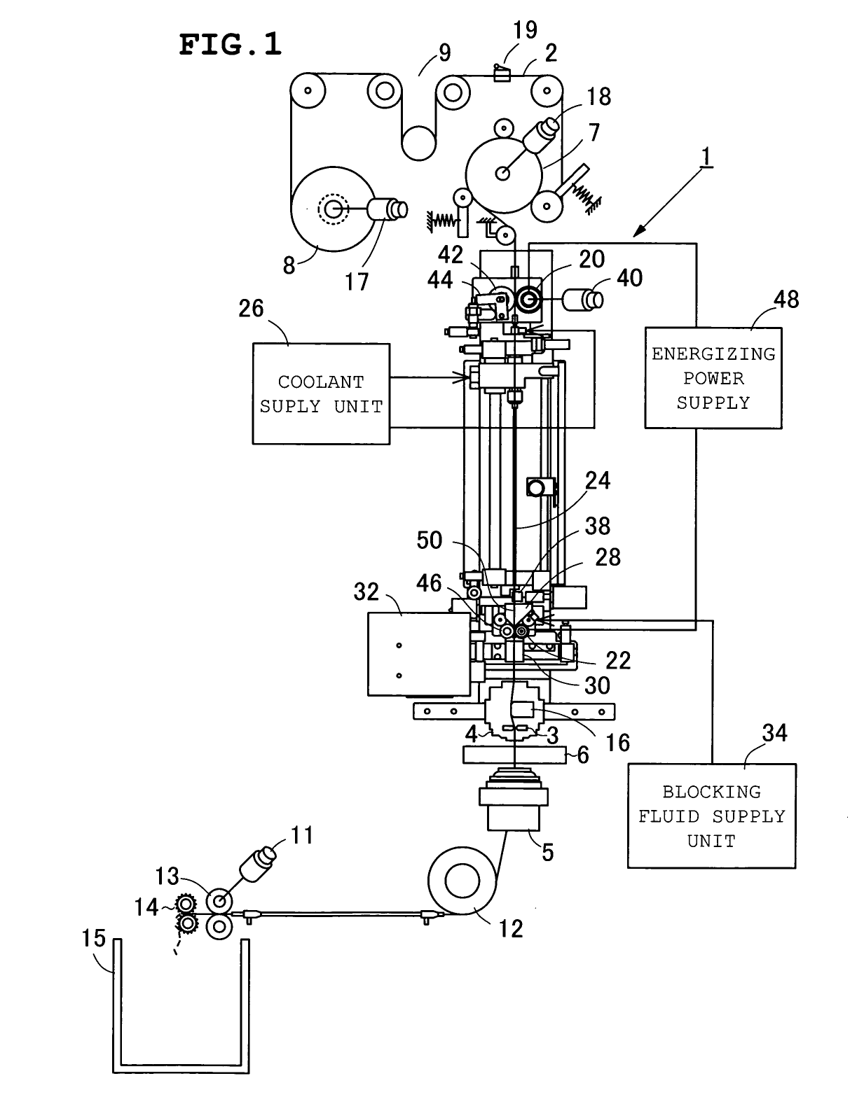

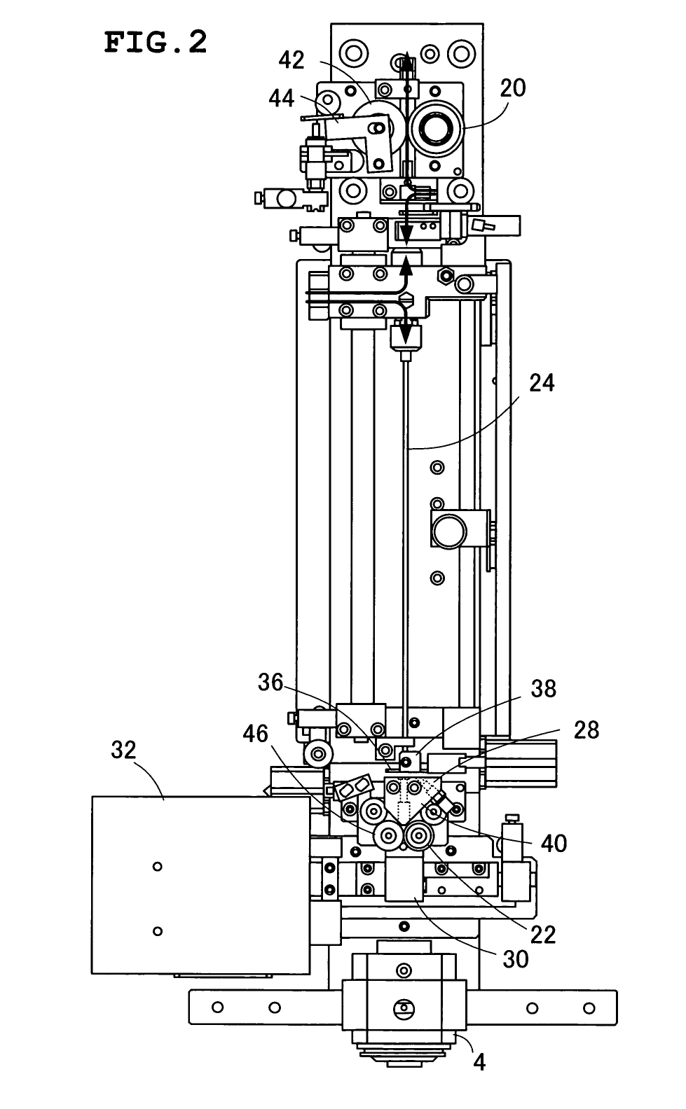

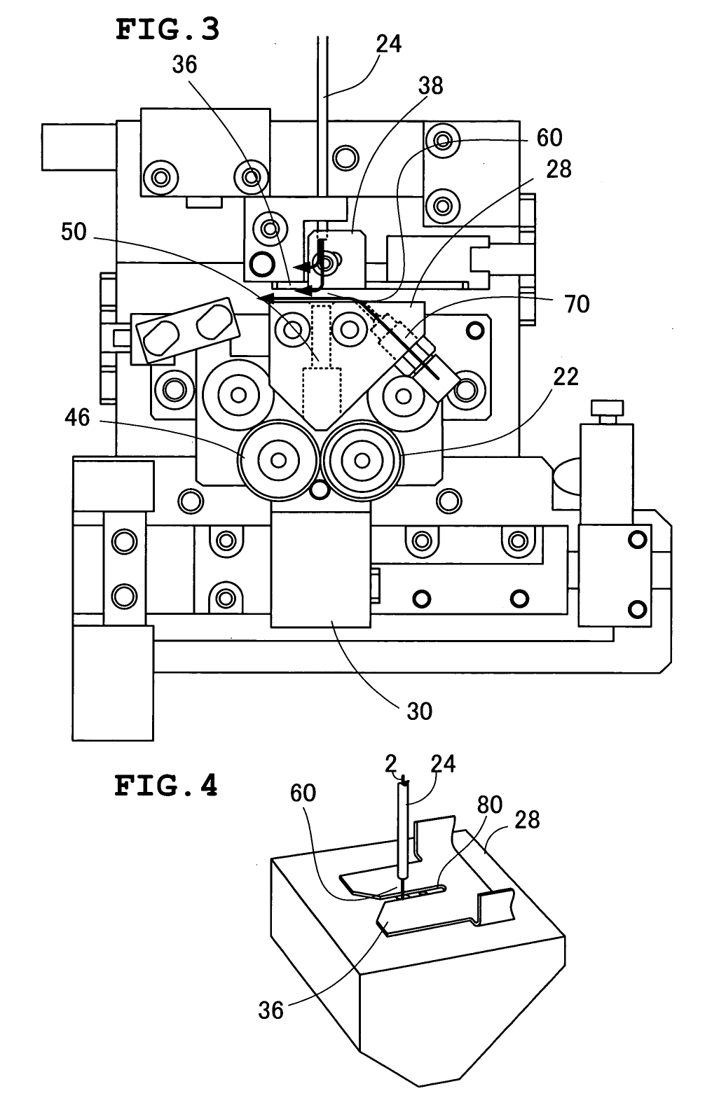

One embodiment of the present invention will now be described with reference to FIG. 1, FIG. 2, FIG. 3 and FIG. 4.

As shown in FIG. 1, an upper guide assembly 4 and a lower guide assembly 5 are arranged on opposite sides of a workpiece 6. An upper wire guide 3 and an upper electric contact 16 are housed within the upper wire assembly 4. The upper wire guide 3 is divided in half, and when closed forms a hole for positioning a wire electrode 2. A clearance between the wire electrode 2 and the upper wire guide 3 is 3 μm to 20 μm. The upper electric contact 16 for delivering machining current to the wire electrode 2 is provided as close as possible to a work gap. A similar lower electric contact (not shown) is housed within the lower wire assembly 5. A lower wire guide (not shown) is a dies guide that is not divided.

The wire electrode 2 is paid out from a bobbin 8 and fed to the upper wire guide 3 via a tension variation preventing mechanism 9, breakage detector 19, tension roller 7 and automatic wire threader 1. A brake 17 for exerting back tension on the wire electrode 2 between the bobbin 8 and the tension roller 7 in order to prevent spinning of the bobbin 8 is connected to the bobbin 8. The brake 17 is, for example, a controllable torque servo motor, or an electromagnetic brake. The tension variation preventing mechanism 9 includes a servo pulley for taking up variation in tension. The breakage detector 19 is a limit switch for detecting unforeseen breakage in the wire electrode 2. The controllable torque servo motor 18 is connected to the tension roller 7. The wire electrode 2 is fed from the upper wire guide 3, through the workpiece 6, lower wire guide and course changing pulley 12 to a pickup roller 13. A controllable torque servo motor 11 is connected to the pickup roller 13. Torques of servo motors 18 and 11 are controlled so as to keep tension of the wire electrode 2 between the upper and lower wire guides at a set value. Tension is normally set in a range of between 600 g to 2,200 g depending on the diameter and material of the wire electrode 2. A chipping unit 14 provided close to the pickup roller 13 cuts the wire electrode 2 into small pieces, and the small pieces are collected in the bucket 15.

As shown in FIG. 1 and FIG. 2, the automatic wire threader 1 is mainly comprised of a pair of roller shaped energized electrodes 20, 22, a guide pipe 24, a coolant supply unit 26, a heat retention unit 28, a blocking fluid supply unit 34, a clamp unit 30 and a collection box 32. The pair of energized electrodes 20, 22, guide pipe 24, heat retention unit 28 and clamp unit 30 are provided along the wire transporting path. The energized electrodes 20, 22 are connected to an energizing power supply 48, and can supply heating current to the wire electrode 2. Heating current is varied by varying a resistance value within the energizing power supply 48. The pair of energized electrodes 20, 22 can hold the wire electrode 2 in cooperation with pinch rollers 42 and 46. The pinch roller 42 is opened and closed by operation of a lever 44. The upper energized electrode 20 may perform a roller function for feeding and winding the wire electrode 2. The guide pipe 24 is a well known component, and is capable of moving up and down by means of a suitable air cylinder. The guide pipe 24 has an outer diameter of 2.0 mm, and an inner diameter of 0.5-1.0 mm so that the wire electrode 2 can pass through the guide pipe 24. The coolant supply unit 26 can supply fluid for cooling the wire electrode 2 through appropriate piping. The heat retention unit 28 is provided directly above the lower energized electrode 22, and has a through hole 50 through which the guide pipe 24 can pass. The heat retention unit 28 maintains a heating temperature around a small part of the wire electrode 2. The guide pipe 24 is positioned between the upper energized electrode 20 and the heat retention unit 28 when annealing and fusing the wire electrode 2. The blocking fluid supply unit 34 supplies blocking fluid for blasting off coolant released from a lower end of the guide pipe 24. Coolant can not flow into the through hole 50 because of the blocking fluid. The clamp unit 30 is provided directly below the lower energized electrode 22. The collection box 32 for collection of cut of f pieces of the wire electrode 2 is provided to the side of the clamp unit 30. The blocking plate 36 is attached to a passage sensor 38, and prevents coolant flowing into the through hole 50. As shown in FIG. 4, the blocking plate 36 covers an upper surface of the heat retention unit 28 and has a slit or hole 80. The blocking plate 36 can be retracted from the wire transporting path using an appropriate air cylinder. The slit 80 is smaller than the outer diameter of the guide pipe 24 and larger than the diameter of the wire electrode 2.

Operation of the automatic wire threader 1 when unforeseen breakage of the wire electrode 2 occurs in the work gap will now be described.

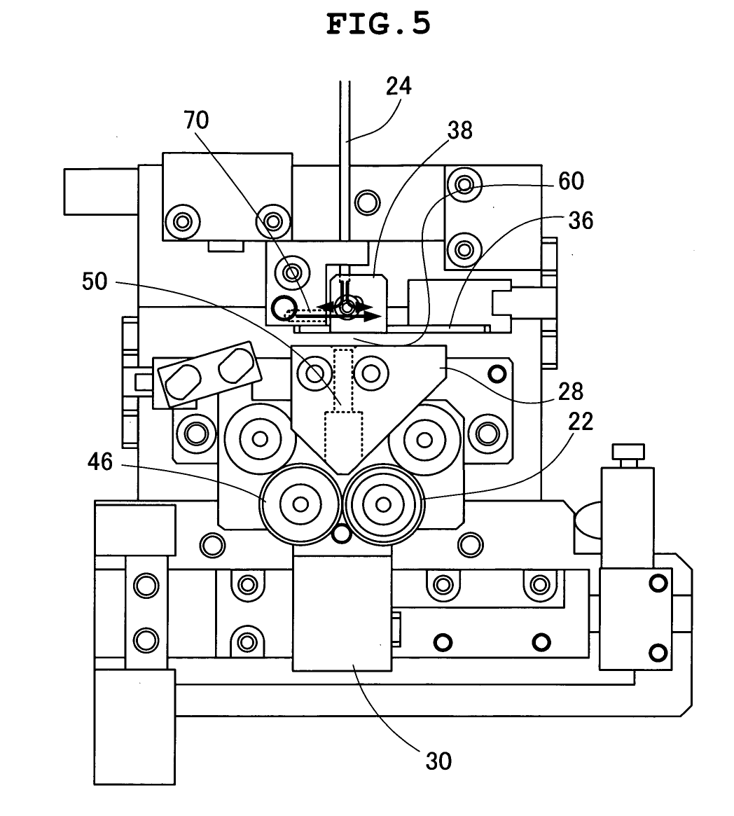

After the breakage has been detected, the used up wire electrode 2 is rejected into the bucket 15 by the pickup roller 13. The guide pipe 24 is then lowered and positioned above the heat retention unit 28 by a specified gap 60, as shown in FIG. 2. After the leading end of the unused wire electrode 2 has been wound on by the tension roller 7 as far as the passage sensor 38, it is lowered down to a specified distance from the lower energized electrode 22. The wire electrode 2 is held by the energized electrode 22 and the pinch roller 46, and is subjected to tension set by the tension roller 7. When using brass wire of f 0.2 mm, for example, tension for annealing is 700 g to 800 g. The wire electrode 2 is held by the upper energized electrode 20 and the pinch roller 42, and heating current is supplied from the energizing power supply 48 to the pair of energized electrodes 20 and 22. When using brass wire of f 0.2 mm, for example, heating current for annealing is 4.0 A to 4.8 A. In this way, the wire electrode 2 is drawn out to become finer and straighter, and threading is made simpler. After annealing for 0.8 to 2 seconds, tension and heating current are increased in order to cause fusing. When using brass wire of f 0.2 mm, for example, tension is 900 g to 1000 g, and heating current is 5.3 A to 6.7 A. Tension and heating current are set in a control unit (not shown) for controlling the servo motor 18 and the energizing power supply 48. Compressed air at 0.5 MPa from the coolant supply unit 26 is supplied as shown by the arrows in FIG. 2. If the coolant is air at room temperature, rise in temperature of the wire electrode 2 between the energized electrodes 20 and 22 can be sufficiently controlled except for the through hole 50. Compressed air supplied into the guide pipe 24 is expelled from the lower end of the guide pipe 24 as shown by the arrows in FIG. 3. The blocking fluid supply unit 34 supplies compressed air to the nozzle 70. The nozzle 70 generates a flow of compressed air 71 traversing the wire electrode 2 inside the gap 60 below the blocking plate 36. This compressed air has the same temperature and pressure as the coolant from the coolant supply unit 26. After that, tension and heating current are increased in order to cause fusing. The coolant does not flow into the through hole 50 of the heat retention unit 28 because of the blocking plate 36 and the flow of compressed air 71. In this way, the wire electrode 2 is fused at a particular place, namely inside the through hole 50. As shown in FIG. 5, it is also possible to use another nozzle 72 instead of the nozzle 70. The nozzle 72 generates a flow of compressed air 73 traversing the wire electrode 2 at right angles in the gap 60 above the blocking plate 36. The fused wire electrode 2 has a tapering round tip with no burrs. Since it is difficult for this wire electrode 2 to get stuck in a hole or machined kerf with small clearance, the success rate of the automatic threading is increased. The clamp unit 30 moves to the side grasping a cut of f piece of the wire electrode 2, and discards the cut of f piece into the collection box 32. The pinch roller 46 and the upper wire guide 3 are opened up, and the blocking plate 36 and the upper electric contact 16 are retracted from the wire transporting path using appropriate air cylinder. The guide pipe 24 and the wire electrode 2 are lowered with the wire electrode 2 projecting slightly from the tip end of the guide pipe 24. With the illustrated embodiment, it is possible to lower the guide pipe 24 down as far as the upper guide assembly 4. If the upper electric contact 16 or the upper wire guide 3 is impeded, the guide pipe 24 is lowered at least as far as the upper end of the upper guide assembly 4. The coolant supply unit 26 supplies air to the inside of the guide pipe 24. The wire electrode 2 is passed through a starting hole or machined kerf in the workpiece 6 by a jet of the air, and threaded into the lower wire guide.

The embodiments have been chosen in order to explain the principles of the invention and its practical applications, and many modifications are possible in light of the above teaching. It is intended that the scope of the invention be defined by the claims appended hereto.

1. An automatic wire threader, for threading a wire electrode through upper and lower wire guides, comprising:
upper and lower energized electrodes for supplying heating current to the wire electrode, provided above the upper wire guide;
a vertically moveable guide pipe through which the wire electrode can pass, provided between the upper and lower energized electrodes;
a heat retention unit, having a through hole through which the guide pipe can pass, provided between the upper and lower energized electrodes;
a coolant supply unit for supplying coolant for cooling the wire electrode in the guide pipe; and
a blocking fluid supply unit for supplying blocking fluid for preventing coolant flowing into the through hole of the heat retention unit.

2. The automatic wire threader of claim 1 further comprising a nozzle for generating a flow of blocking fluid traversing the wire electrode in a gap formed between the guide pipe and the heat retention unit.

3. An automatic wire threader, for threading a wire electrode through upper and lower wire guides, comprising:
upper and lower energized electrodes for supplying heating current to the wire electrode, provided above the upper wire guide;
a vertically moveable guide pipe through which the wire electrode can pass, provided between the upper and lower energized electrodes;
a heat retention unit, having a through hole through which the guide pipe can pass, provided between the upper and lower energized electrodes;
a coolant supply unit for supplying coolant for cooling the wire electrode in the guide pipe; and
a blocking plate for preventing coolant flowing into the through hole of the heat retention unit.
